(19) United States
(12) Patent Application Publication
(10) Pub. No.: US 2017/0110701 A1
(43) Pub. Date: Apr. 20, 2017

(54) INTEGRATED ELECTRODE ASSEMBLY

(71) Applicant: Lubrizol Advanced Materials, Inc., Cleveland, OH (US)

(72) Inventors: Xiangfu Shi, Solon, OH (US); Greg S. Nestlerode, Norton, OH (US); Qiwei Lu, Seven Hills, OH (US)

(21) Appl. No.: 15/312,070

(22) PCT Filed: May 14, 2015
(86) PCT No.: PCT/US2015/030705

§ 371 Date: Nov. 17, 2016

Related U.S. Application Data
(60) Provisional application No. 62/001,138, filed on May 21, 2014.

(51) Int. Cl. H01M 2/16; H01M 4/136; H01M 4/133; H01M 4/36; H01M 4/58; C09D 175/06; H01M 4/62; H01M 10/0525; H01M 10/0565; C08G 18/76; C08G 18/66; H01M 2/14; H01M 4/587

(52) U.S. Cl. CPC H01M 2/1673; H01M 2/1653; H01M 2/145; H01M 4/136; H01M 4/133; H01M 4/364; H01M 4/5825; H01M 4/587; H01M 4/623; H01M 4/625; H01M 4/626; H01M 10/0525; H01M 10/0565; C08G 18/7671; C08G 18/664; C09D 175/06; H01M 2004/027

(57) ABSTRACT

The disclosed technology relates to electrodes with a polyurethane based melt coating present in the electrode. When the electrode is used in an electrochemical cell, the polyurethane based melt coating acts as a separator in the cell. The disclosed technology includes integrated electrode assemblies that include (A) an electrode; and (B) a separator comprising an ionically conductive thermoplastic polyurethane composition; wherein the separator is melt coated onto the electrode. Also included are electro chemical cells made with these electrodes or integrated electrode assemblies, and processes of making the same.

### BACKGROUND OF THE INVENTION

The disclosed technology relates to electrodes with a polyurethane based melt coating present in the electrodes. When the electrode is used in an electrochemical cell, the polyurethane based melt coating acts as a separator in the cell. The disclosed technology includes integrated electrode assemblies that include (A) an electrode; and (B) a separator comprising an ionically conductive thermoplastic polyurethane composition; wherein the separator is melt coated onto the electrode. Also included are electrochemical cells made with these electrodes or integrated electrode assemblies, and processes of making the same.

A rechargeable (also called secondary) lithium-ion (Li-ion) battery is a most important family member of rechargeable battery types in which lithium ions move between the positive electrode and the negative electrode during charge and discharge. Li-ion batteries (LIB) have become the most commonly used batteries in portable consumer electronics due to their high energy densities, lack of memory effect, and a slow self-discharge when not in use. Beyond consumer electronics, Li-ion batteries are also growing in popularity for military, electric vehicle, and aerospace applications. Research and development on improvements of traditional Li-ion battery technology has been focusing on energy density, durability, cost, and intrinsic safety, as there are industry recognized needs to improve the technology in all of these areas.

There are four primary functional components of a conventional Li-ion battery: anode, cathode, separator, and electrolyte. The anode of a conventional lithium-ion cell is commonly made from carbon, the cathode is generally a metal oxide, the separator is generally a micro-porous polyolefin membrane, and the electrolyte is generally a lithium salt in an organic solvent. Facing safety concerns and form factor constrictions, efforts have been made to replace the conventional separator plus electrolyte with a gel-type formulation (e.g., polyvinylidene fluoride) or even a solid polymer (e.g., polyethylene oxide) film. The new types of Li-ion batteries are generally called lithium ion polymer (Li-Poly) batteries, which may find great needs and potentials in the emerging electric vehicle evolution. However, due to their lower Li+ conductivity and electrode compatibility and as well as their higher cost, Li-ion poly batteries have seen significantly limited commercial growth.

Conventional LIB cell fabrication processes involve high tensile load on the separator films and demands good mechanical stiffness and strength of the films. The incumbent cell winding machines are well suited for existing stiff and strong polyolefin based membranes but have very limited room to adapt to new types of materials, especially materials that stretch or are overly flexible. Further, there is a clear trend in the industry to use increasingly thinner separator films in order to achieve higher energy density and better rate capability and power performance of the LIB cells. In addition, surface modifications to improve adhesion between separator and electrode have been and is still under extensive investigation throughout the battery industry. All of these factors add to the complications of using thermoplastic polyurethane (TPU) elastomers in LIB cells. TPU elastomers are generally too stretchy for current winding machines used to manufacture LIB cells, and thus cannot be a drop-in solution to the incumbent LIB cell assembly processes in the industry. Also the market's desire for thinner films results in the need to use thinner gauge TPU elastomers, which results in more defects in the TPU elastomer film, (e.g., pin holes in the separator), which can lead to battery failure. The present invention overcomes these barriers to using TPU in commercially produced. LIB cells.

### SUMMARY OF THE INVENTION

The disclosed technology provides an integrated electrode assembly that includes (A) an electrode and (B) a separator comprising an ionically conductive thermoplastic polyurethane composition where the separator is melt coated onto the electrode.

The disclosed technology provides the described integrated electrode assembly where the electrode includes (i) a current collector, (ii) an electro-active material, (iii) an electrode binder composition, and optionally (iv) a conducting agent.

The disclosed technology provides the described integrated electrode assembly where the electrode binder composition includes a polyvinylidene fluoride (PVDF), a styrene-butadiene rubber (SBR), a thermoplastic polyurethane (TPU), or a combination thereof.

The disclosed technology provides the described integrated electrode assembly where the conducting agent includes carbon black, carbon nanotube, graphene, nickel powder, or a combination thereof. In some embodiments, the conducting agent may be a metallic powder.

The disclosed technology provides the described integrated electrode assembly where the electro-active material is a cathode active material including or selected from the group consisting of: lithium composite oxides; elemental sulfur; casolite containing dissolved Li₂Sₙ where n is greater than or equal to 1; organosulfur; (C₂Sₓ)_{y} where x is from 2.5 to 20 and y is greater than or equal to 2; and a combination thereof. The cathode active material may include lithium cobalt oxide (LiCoO), lithium iron phosphate (LFP), lithium manganese oxide (LMO), lithium nickel manganese cobalt oxide (NMC), lithium nickel cobalt aluminum oxide (NCA), lithium titanate (LTO). The cathode active material may also include LiNiMnCoO₂ or LiFePO₄.

The disclosed technology provides the described integrated electrode assembly where the electro-active material is an anode active material including or selected from the group consisting of: a graphite-based material; a first compound containing at least one of Al, Si, Sn, Ag, Bi, Mg, Zn, In, Ge, Pb, and Ti; a composite of the first compound, the graphite-based material, and carbon; a lithium-containing nitride; and a combination thereof. The anode active material may include lithium cobalt oxide (LiCoO), lithium iron phosphate (LFP), lithium manganese oxide (LMO), lithium nickel manganese cobalt oxide (NMC), lithium nickel cobalt aluminum oxide (NCA), lithium titanate (LTO). The anode active material may include composite graphite.

The disclosed technology provides the described integrated electrode assembly where the ionically conductive thermoplastic polyurethane composition of the separator includes the reaction product of: (i) a polyisocayante, (ii) a hydroxyl terminated intermediate, and (iii) an alkylene diol chain extender.

The disclosed technology provides the described integrated electrode assembly where the hydroxyl terminated intermediate includes a polyether polyol, a polyester polyol, a polycarbonate polyol, a polyamide polyol, or any combination thereof.

The disclosed technology provides the described integrated electrode assembly where the ionically conductive thermoplastic polyurethane composition of the separator is made by reacting (i) at least one hydroxyl terminated intermediate with (ii) at least one diisocyanate and (iii) at least one chain extender; wherein (i), the hydroxyl terminated intermediate, comprises a poly(ethylene glycol) or an intermediate derived from at least one dialkylene glycol and at least one di-carboxylic acid, or an ester or anhydride thereof; wherein (ii), the diisocyanate, comprises: 4,4′-methylenebis-(phenyl isocyanate); hexamethylene diisocyanate; 3,3′-dimethylbiphenyl-4,4′-diisocyanate; m-xylylene diisocyanate; phenylene-1,4-diisocyanate; naphthalene-1,5-diisocyanate; diphenylmethane-3,3′-dimethoxy-4,4′-diisocyanate; toluene diisocyanate; isophorone diisocyanate; 1,4-cyclohexyl diisocyanate; decane-1,10-diisocyanate; dicyclohexylmethane-4,4′-diisocyanate; or combinations thereof; wherein (iii), the chain extender, comprises: hydroquinone bis (beta-hydroxyethyl) ether; ethylene glycol; diethylene glycol; propylene glycol; dipropylene glycol; 1,4-butanediol; 1,6-hexanediol; 1,3-butanediol; 1,5-pentanediol; neopentylglycol; or combinations thereof; and wherein the di-carboxylic acid contains from 4 to 15 carbon atoms and the dialkylene glycol contains from 2 to 8 aliphatic carbon atoms.

The disclosed technology provides the described integrated electrode assembly where the ionically conductive thermoplastic polyurethane composition of the separator includes the reaction product of: (i) a 4,4′-methylenebis-(phenyl isocyanate), (ii) a hydroxyl terminated poly(ethylene glycol) or an intermediate derived from at least one dialkylene glycol and adipic acid, and (iii) and hydroquinone bis (beta-hydroxyethyl) ether.

The disclosed technology provides the described integrated electrode assembly where the ionically conductive thermoplastic polyurethane composition of the separator further includes at least one additional additive, comprising a plasticizer, a lubricant, an antioxidant, a heat stabilizer, hydrolytic stabilizer, an acid scavenger, mineral and/or inert filler, a nano filler, a flame retardant, a second polymer component, a compatibilizer, or any combination thereof.

The disclosed technology provides an electrochemical cell comprising the integrated electrode assembly described herein.

The disclosed technology provides the described electrochemical cell wherein the electrochemical cell includes: (I) an integrated electrode assembly including: (A) an electrode; and (B) a first separator comprising a thermoplastic polyurethane composition; wherein the first separator is melt coated onto the electrode; (II) an electrode which is not melt coated with a thermoplastic polyurethane composition; and (III) an electrolyte.

The disclosed technology provides the described electrochemical cell wherein the electrochemical cell includes: (I) an integrated electrode assembly including: (A) an anode; and (B) a first separator comprising a thermoplastic polyurethane composition; wherein the first separator is melt coated onto the anode; (II) an integrated electrode assembly comprising: (C) a cathode; and (D) a second separator comprising a thermoplastic polyurethane composition; wherein the first separator is melt coated onto the cathode; and (III) an electrolyte.

The disclosed technology provides a process of making an integrated electrode assembly including the steps of: (I) melt coating a separator which includes a thermoplastic polyurethane composition onto am electrode; and (B) a separator comprising a thermoplastic polyurethane composition; wherein the separator is melt coated onto the electrode.

The disclosed technology provides an electrochemical cell wherein the cell includes: (a) an anode layer; (b) a first separator comprising a first thermoplastic polyurethane composition; wherein the first separator is melt coated onto at least one major surface of the anode, forming an integrated anode assembly; (c) an cathode layer; (d) a second separator comprising a second thermoplastic polyurethane composition; wherein the second separator is melt coated onto at least one major surface of the cathode, forming an integrated cathode assembly; and (e) an electrolyte; wherein the combined anode separator assembly and the combined cathode separator assembly are positioned next to each other such that the melt coated major surface of the anode is adjacent to the melt coated major surface of the cathode; and wherein the electrolyte is present between the combined anode separator assembly and the combined cathode separator assembly and optionally permeates the first separator and second separator.

### DETAILED DESCRIPTION OF THE INVENTION

Various preferred features and embodiments will be described below by way of non-limiting illustration.

Our earlier thermoplastic polyurethane (TPU) elastomer based separator films have high stretchiness, while the incumbent cell fabrication process in LiB industry demands high stiffness, high strength and defect-free membranes. It has proven extremely challenging to produce wide (e.g., 20″ or more), thin gauge (e.g., <20 microns), and high quality (e.g., 100% defect free with no pin holes) TPU elastomer based films that can survive the current LIB cell manufacturing process, and in particular the current winding machines, which can stretch the TPU elastomer based film to the point of creating defects.

With these barriers in mind, we have developed an alternative approach. Instead of supplying a free-standing (i.e., separate) TPU elastomer film to be used in place of a conventional separator film, we have instead developed TPU materials that we can melt coat directly onto the electrode, including either anodes or cathodes (or both). With the TPU separator present as a melt coating on the electrode, we avoid the need for a TPU film to be processed. As the electrode would provide the physical integrity needed, and prevent the TPU film from seeing much of the stress and strain of the cell manufacturing process, this approach greatly lessens the stringent requirements on the separator films and mitigates cell quality incidents caused by defects in the separator film. Further, this approach greatly improves the overall adhesion of the separator film to the electrodes. When properly designed to provide good adhesion between the TPU separator film and electrode substrates, the devised approach enables integration of separator films with electrodes and thus eliminates the high tensile load on the separator films during cell winding process. Further, this new approach also enables thinner gauge than conventional polymer film extrusion process.

While not wishing to be bound by theory, we believe this new approach the benefits it provides is unique to TPU base separator films because (a) our TPU based separator films are dense and free of micro pores; and (b) our TPU has excellent adhesion properties to the electrode materials.

The invention provides an integrated electrode assembly that includes (A) an electrode; and (B) a separator comprising an ionically conductive thermoplastic polyurethane composition; wherein the separator is melt coated onto the electrode.

### The Electrode.

The integrated electrode assembly includes an electrode. The electrodes useful in the described technology are not overly limited, so long as they are suitable for use in a LIB cell. Further, good adhesion after melt-coating is needed between the electrode and the ionically conductive thermoplastic polyurethane composition used in the separator.

The electrode utilize in the invention may be a positive electrode, a negative electrode, or both. The positive electrode may be fabricated of any of a number of chemical systems known to those of ordinary skill in the art. Examples of such systems include, but are not limited to, manganese oxide, nickel oxide, cobalt oxide, vanadium oxide, and combinations thereof. The negative electrode may likewise be fabricated from any of a number of electrode materials known to those of ordinary skill in the art. Selection of the negative electrode material is dependent on the selection of the positive electrode so as to assure an electrochemical cell which will function properly for a given application. Accordingly, the negative electrode may be fabricated from, for example, alkali metals, alkali metal alloys, carbon, graphite, petroleum coke, and combinations thereof.

In some embodiments, the electrode may be a sheet-type electrode or may be a coating on metallic foils.

It is noted that in the present invention the described thermoplastic polyurethane compositions are present as a melt coated layer of the electrode. This is different from simply being referred to as a top coating layer as such a term is generic and may refer to any of a large number of coatings, coating applications and techniques. A melt coated layer requires the thermoplastic polyurethane composition to be applied in a melted state whereas no such means of application is required nor implied when referring to a top coating layer.

In some embodiments, the electrode includes (i) a current collector, (ii) an electro-active material, (iii) an electrode binder composition, and optionally (iv) a conducting agent.

The current collector may be a cathode current collector or an anode current collector, depending on whether the electrode involved is a cathode or anode.

The cathode current collector may be fabricated to a thickness of 3 to 500 micrometers. Suitable cathode current collectors are not particularly limited so long as it does not cause chemical changes in the LIB cell and has high conductivity. For example, the cathode current collector may be made of copper, stainless steel, aluminum, nickel, titanium, sintered carbon, copper or stainless steel surface-treated with carbon, nickel, titanium, silver, or the like, an aluminum-cadmium alloy, or the like. The cathode current collector may have fine irregularities on the surface thereof to increase adhesion between the electro-active cathode material and the cathode current collector. In addition, the cathode current collector may be used in any of various forms including films, sheets, foils, nets, porous structures, foams, and non-woven fabrics.

The anode current collector may be fabricated to a thickness of 3 to 500 micrometers. The anode current collector is not particularly limited so long as it does not cause chemical changes in the LIB cell and has conductivity. For example, the anode current collector may be made of copper, stainless steel, aluminum, nickel, titanium, sintered carbon, copper or stainless steel surface-treated with carbon, nickel, titanium, or silver, aluminum-cadmium alloys, or the like. As in the cathode current collector, the anode current collector may also have fine irregularities on the surface thereof to enhance adhesion between the anode current collector and the electro-active anode material. In addition, the anode current collector may be used in various forms including films, sheets, foils, nets, porous structures, foams, and non-woven fabrics.

The electro-active material may be a cathode active material or an anode active material. Suitable electro-active materials are generally not limited and may include any of those useful in LIB cells.

In some embodiments, the electro-active material is a cathode active material selected from the group consisting of: lithium composite oxides; elemental sulfur; casolite containing dissolved Li₂Sₙ where n is greater than or equal to 1; organosulfur; (C₂Sₓ)_{y} where x is from 2.5 to 20 and y is greater than or equal to 2; and a combination thereof.

In some embodiments, the electro-active material is an anode active material selected from the group consisting of: a graphite-based material; a first compound containing at least one of Al, Si, Sn, Ag, Bi, Mg, Zn, In, Ge, Pb, and Ti; a composite of the first compound, the graphite-based material, and carbon; a lithium-containing nitride; and a combination thereof.

The electrode binder compositions are generally not limited and may include any of those useful in LIB cells.

Suitable electrode binder compositions include polyvinylidene fluoride (PVDF), styrene-butadiene rubber (SBR), thermoplastic polyurethane (TPU), or any combination thereof.

The binder composition may optionally further include an organic solvent. Suitable organic solvents include dimethylformamide (DMF); dimethylsulfoxide (DMSO); dimethylacetamide (DMA); acetone; N-methyl-2-pyrrolidone; and a combination thereof.

The conducting agents are generally not limited and may include any of those useful in LIB cells.

Suitable conducting agents include carbon-based conducting fillers, nickel powder, or a combination thereof. Examples of carbon-based conducting fillers include carbon black, nano carbon fibers, carbon nano tubes, grapheme, or combinations thereof. The binder composition may optionally further include a conducting agent.

In some embodiments the conducting agent comprises carbon black, carbon nanotube, graphene, nickel powder, or a combination thereof.

In some embodiments, the electrode includes (i) a current collector, (ii) an electro-active material, (iii) an electrode binder composition, and (iv) a conducting agent; where the current collector (whether it be an anode or cathode) is a film, sheet, and/or foil, made of copper, stainless steel, aluminum, nickel, titanium, sintered carbon, copper or stainless steel surface-treated with carbon, nickel, titanium, silver, or the like, an aluminum-cadmium alloy, or the like; where the electro-active material is (i) a cathode active material selected from the group consisting of: lithium composite oxides; elemental sulfur; casolite containing dissolved Li₂Sₙ where n is greater than or equal to 1; organosulfur; (C₂Sₓ)_{y} where x is from 2.5 to 20 and y is greater than or equal to 2; and a combination thereof; or (ii) an anode active material selected from the group consisting of: a graphite-based material; a first compound containing at least one of Al, Si, Sn, Ag, Bi, Mg, Zn, In, Ge, Pb, and Ti; a composite of the first compound, the graphite-based material, and carbon; a lithium-containing nitride; and a combination thereof; wherein the electrode binder is polyvinylidene fluoride (PVDF), styrene-butadiene rubber (SBR), thermoplastic polyurethane (TPU), or any combination thereof; and wherein the conducting agent is carbon black, carbon nanotube, graphene, nickel powder, or a combination thereof.

In some embodiments, the electrodes described herein include: a current collector made of copper or aluminum; an electro-active material that includes LiNiMnCoO₂ or LiFePO₄: a binder composition that includes polyvinylidene fluoride, polyvinylidene difluoride, a thermoplastic polyurethane, or any combination thereof; a carbon based conducting agent. The thermoplastic polyurethane of the binder composition may be the same thermoplastic polyurethane used in the melt coatings described herein, or it may be different.

### The Separator.

The disclosed technology utilizes a separator that includes an ionically conductive thermoplastic polyurethane composition where the separator is melt coated onto the electrode. By ionically conductive, in some embodiments, it is meant that the TPU has a Li+ conductivity of >1.0×10⁻⁶ or even >1.0×10⁻⁵ or even >1.0×10⁻⁴ S/cm as measured with a Solartron analytical system at room temperature. In other embodiments it is meant that the TPU is made from a hydroxyl terminated intermediate, comprises a poly(ethylene glycol) or an intermediate derived from at least one dialkylene glycol and at least one di-carboxylic acid, or an ester or anhydride thereof. In still other embodiment, the disclosed technology may be described as utilizing a separator that includes a thermoplastic polyurethane composition, which may be further described using any of the features contained herein.

The thermoplastic polyurethane (TPU) of the ionically conductive thermoplastic polyurethane composition may be the reaction product of (i) a polyisocayante, (ii) a hydroxyl terminated intermediate, and (iii) an alkylene diol chain extender.

The TPU described herein are made using (a) a polyisocyanate component. The polyisocyanate and/or polyisocyanate component includes one or more polyisocyanates. In some embodiments, the polyisocyanate component includes one or more diisocyanates.

In some embodiments, the polyisocyanate and/or polyisocyanate component includes an alpha, omega-alkylene diisocyanate having from 5 to 20 carbon atoms.

Suitable polyisocyanates include aromatic diisocyanates, aliphatic diisocyanates, or combinations thereof. In some embodiments, the polyisocyanate component includes one or more aromatic diisocyanates. In some embodiments, the polyisocyanate component is essentially free of, or even completely free of, aliphatic diisocyanates. In other embodiments, the polyisocyanate component includes one or more aliphatic diisocyanates. In some embodiments, the polyisocyanate component is essentially free of, or even completely free of, aromatic diisocyanates.

Examples of useful polyisocyanates include aromatic diisocyanates such as 4,4′-methylenebis(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, lysine diisocyanate (LDI), 1,4-butane diisocyanate (BDI), isophorone diisocyanate (PDI), 3,3′-dimethyl-4,4′-biphenylene diisocyanate (TODI), 1,5-naphthalene diisocyanate (NDI), and dicyclohexylmethane-4,4′-diisocyanate (H12MDI). Mixtures of two or more polyisocyanates may be used. In some embodiments, the polyisocyanate is MDI and/or H12MDI. In some embodiments, the polyisocyanate includes MDI. In some embodiments, the polyisocyanate includes H12MDI.

In some embodiments, the thermoplastic polyurethane is prepared with a polyisocyanate component that includes H12MDI. In some embodiments, the thermoplastic polyurethane is prepared with a polyisocyanate component that consists essentially of H12MDI. In some embodiments, the thermoplastic polyurethane is prepared with a polyisocyanate component that consists of H12MDI.

In some embodiments, the thermoplastic polyurethane is prepared with a polyisocyanate component that includes (or consists essentially of, or even consists of) H12MDI and at least one of MDI, HDI, TDI, IPDI, LDI, BDI, PDI, CHDI, TODI, and NDI.

In some embodiments, the polyisocyanate used to prepare the TPU and/or TPU compositions described herein is at least 50%, on a weight basis, a cycloaliphatic diisocyanate. In some embodiments, the polyisocyanate includes an alpha, omega-alkylene diisocyanate having from 5 to 20 carbon atoms.

In some embodiments, the polyisocyanate used to prepare the TPU and/or TPU compositions described herein includes hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, or combinations thereof.

The TPU compositions described herein are made using (b) a polyol component. Polyols include polyether polyols, polyester polyols, polycarbonate polyols, polysiloxane polyols, polyamide polyols, and combinations thereof.

Suitable polyols, which may also be described as hydroxyl terminated intermediates, when present, may include one or more hydroxyl terminated polyesters, one or more hydroxyl terminated polyethers, one or more hydroxyl terminated polycarbonates, one or more hydroxyl terminated polysiloxanes, or mixtures thereof.

Suitable hydroxyl terminated polyester intermediates include linear polyesters having a number average molecular weight (Mn) of from about 500 to about 10,000, from about 700 to about 5,000, or from about 700 to about 4,000, and generally have an acid number less than 1.3 or less than 0.5. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from 8-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycols described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

The polyol component may also include one or more polycaprolactone polyester polyols. The polycaprolactone polyester polyols useful in the technology described herein include polyester diols derived from caprolactone monomers. The polycaprolactone polyester polyols are terminated by primary hydroxyl groups. Suitable polycaprolactone polyester polyols may be made from 8-caprolactone and a bifunctional initiator such as diethylene glycol, 1,4-butanediol, or any of the other glycols and/or diols listed herein. In some embodiments, the polycaprolactone polyester polyols are linear polyester diols derived from caprolactone monomers.

Useful examples include CAPA™ 2202A, a 2000 number average molecular weight (Mn) linear polyester diol, and CAPA™ 2302A, a 3000 Mn linear polyester diol, both of which are commercially available from Perstorp Polyols Inc. These materials may also be described as polymers of 2-oxepanone and 1,4-butanediol.

The polycaprolactone polyester polyols may be prepared from 2-oxepanone and a diol, where the diol may be 1,4-butanediol, diethylene glycol, monoethylene glycol, 1,6-hexanediol, 2,2-dimethyl-1,3-propanediol, or any combination thereof. In some embodiments, the diol used to prepare the polycaprolactone polyester polyol is linear. In some embodiments, the polycaprolactone polyester polyol is prepared from 1,4-butanediol. In some embodiments, the polycaprolactone polyester polyol has a number average molecular weight from 500 to 10,000, or from 500 to 5,000, or from 1,000 or even 2,000 to 4,000 or even 3000.

Suitable hydroxyl terminated polyether intermediates include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, polypropylene glycol) comprising propylene oxide reacted with propylene glycol, poly(tetramethylene ether glycol) comprising water reacted with tetrahydrofuran which can also be described as polymerized tetrahydrofuran, and which is commonly referred to as PTMEG. In some embodiments, the polyether intermediate includes PTMEG. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the described compositions. Typical copolyethers include the reaction product of THF and ethylene oxide or THF and propylene oxide. These are available from BASF as PolyTHF® B, a block copolymer, and poly THF® R, a random copolymer. The various polyether intermediates generally have a number average molecular weight (Mn) as determined by assay of the terminal functional groups which is an average molecular weight greater than about 700, such as from about 700 to about 10,000, from about 1,000 to about 5,000, or from about 1,000 to about 2,500. In some embodiments, the polyether intermediate includes a blend of two or more different molecular weight polyethers, such as a blend of 2,000 Mₙ and 1000 Mₙ PTMEG.

Suitable hydroxyl terminated polycarbonates include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecule with each alkoxy group containing 2 to 4 carbon atoms. Suitable diols include aliphatic diols containing 4 to 12 carbon atoms such as 1,4-butanediol, 1,5-pentanediol, neopentyl glycol, 1,6-hexanediol, 2,2,4-trimethyl-1,6-hexanediol, 1,10-decanediol, hydrogenated dilinoleylglycol, hydrogenated dioleylglycol, 3-methyl-1,5-pentanediol; and cycloaliphatic diols such as 1,3-cyclohexanediol, 1,4-dimethylolcyclohexane, 1,4-cyclohexanediol-, 1,3-dimethylolcyclohexane-, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Suitable polysiloxane polyols include alpha-omega-hydroxyl or amine or carboxylic acid or thiol or epoxy terminated polysiloxanes. Examples include poly(dimethysiloxane) terminated with a hydroxyl or amine or carboxylic acid or thiol or epoxy group. In some embodiments, the polysiloxane polyols are hydroxyl terminated polysiloxanes. In some embodiments, the polysiloxane polyols have a number-average molecular weight in the range from 300 to 5,000, or from 400 to 3,000.

Polysiloxane polyols may be obtained by the dehydrogenation reaction between a polysiloxane hydride and an aliphatic polyhydric alcohol or polyoxyalkylene alcohol to introduce the alcoholic hydroxy groups onto the polysiloxane backbone.

In some embodiments, the polysiloxanes may be represented by one or more compounds having the following formula:

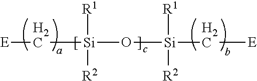

in which: each R¹ and R² are independently a 1 to 4 carbon atom alkyl group, a benzyl, or a phenyl group; each E is OH or NHR³ where R³ is hydrogen, a 1 to 6 carbon atoms alkyl group, or a 5 to 8 carbon atoms cyclo-alkyl group; a and b are each independently an integer from 2 to 8; c is an integer from 3 to 50. In amino-containing polysiloxanes, at least one of the E groups is NHR³. In the hydroxyl-containing polysiloxanes, at least one of the E groups is OH. In some embodiments, both R¹ and R² are methyl groups.

Suitable examples include alpha-omega-hydroxypropyl terminated poly(dimethysiloxane) and alpha-omega-amino propyl terminated poly(dimethysiloxane), both of which are commercially available materials. Further examples include copolymers of the poly(dimethysiloxane) materials with a poly(alkylene oxide).

The polyol component, when present, may include poly(ethylene glycol), poly(tetramethylene ether glycol), poly(trimethylene oxide), ethylene oxide capped polypropylene glycol), poly(butylene adipate), poly(ethylene adipate), poly(hexamethylene adipate), poly(tetramethylene-co-hexamethylene adipate), poly(3-methyl-1,5-pentamethylene adipate), polycaprolactone diol, poly(hexamethylene carbonate) glycol, poly(pentamethylene carbonate) glycol, poly(trimethylene carbonate) glycol, dimer fatty acid based polyester polyols, vegetable oil based polyols, or any combination thereof.

Examples of dimer fatty acids that may be used to prepare suitable polyester polyols include Priplast™ polyester glycols/polyols commercially available from Croda and Radia® polyester glycols commercially available from Oleon.

In one embodiment, the polyol compound comprises a telechelic polyamide. Telechelic polyamides are polyamide oligomers with specified percentages of two functional groups of a single chemical type. Ranges for the percent difunctional that are preferred to meet the definition of telechelic are at least 70 or 80. The telechelic polyamide can comprise: (a) two functional end groups selected from hydroxyl, carboxyl, or primary or secondary amine; and (b) a polyamide segment wherein: (i) said polyamide segment comprises at least two amide linkages characterized as being derived from reacting an amine with a carboxyl group; (ii) said polyamide segment comprises repeat units derived from polymerizing two or more monomers selected from the group consisting of lactam monomers, aminocarboxylic acids monomers, dicarboxylic acids monomers, and diamine monomers. The telechelic polyamide, in some embodiments, may be characterized as a liquid with a viscosity of less than 100,000 cps at 70° C. as measured by a Brookfield circular disc viscometer with the circular disc spinning at 5 rpm. In some embodiments, the telechelic polyamide is characterized by a weight average molecular weight from about 200 to 10,000 g/mole and comprises a diversity of amide forming repeating units disrupting hydrogen bonding between amide components.

In some embodiments, the polyol component includes a polyester polyol. In some embodiments, the polyol component is essentially free of or even completely free of any polyols other than polyester polyols. In such embodiments, the polyester polyol may be an adipate of a dialkylene glycol and in some embodiments an adipate of diethylene glycol.

In some embodiments, the polyol component includes ethylene oxide, propylene oxide, butylene oxide, styrene oxide, poly(tetramethylene ether glycol), poly(propylene glycol), poly(ethylene glycol), copolymers of poly(ethylene glycol) and poly(propylene glycol), epichlorohydrin, and the like, or combinations thereof. In some embodiments, the polyol component includes poly(tetramethylene ether glycol).

In some embodiments, the polyol has a number average molecular weight of at least 900. In other embodiments, the polyol has a number average molecular weight of at least 900, 1,000, 1,500, 1,750, and/or a number average molecular weight up to 5,000, 4,000, 3,000, 2,500, or even 2,000.

The TPU compositions described herein are made using c) a chain extender component. Chain extenders include diols, diamines, and combination thereof.

Suitable chain extenders include relatively small polyhydroxy compounds, for example lower aliphatic or short chain glycols having from 2 to 20, or 2 to 12, or 2 to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy) phenyl]propane (HEPP), hexamethylenediol, heptanediol, nonanediol, dodecanediol, 3-methyl-1,5-pentanediol, ethylenediamine, butanediamine, hexamethylenediamine, hydroquinone bis (beta-hydroxyethyl) ether (HQEE) and hydroxyethyl resorcinol (HER), and the like, as well as mixtures thereof. In some embodiments, the chain extender includes BDO, HDO, 3-methyl-1,5-pentanediol, or a combination thereof. In some embodiments, the chain extender includes BDO. Other glycols, such as aromatic glycols could be used, but in some embodiments the TPUs described herein are essentially free of or even completely free of such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, HQEE, and combinations thereof. In some embodiments, the chain extender used to prepare the TPU includes an aromatic cyclic chain extender, for example, HEPP, HER, HQEE or a combination thereof. In some embodiments, the chain extender used to prepare the TPU includes an aromatic cyclic chain extender, for example, HQEE. In some embodiments, the chain extender used to prepare the TPU includes HQEE, BDO or a combination thereof and in still further combinations HQEE. In some embodiments, the chain extender used to prepare the TPU is substantially free of, or even completely free of aliphatic chain extenders.

While not wishing to be bound by theory, it is believed that the melting point of the TPU is an important feature of the present invention. In some embodiments, the melting point of the TPU composition is at least 140° C. In other embodiments the melting point is from 140 to 250° C.

In some embodiments, the mole ratio of the chain extender to the polyol is greater than 1.5. In other embodiments, the mole ratio of the chain extender to the polyol is at least (or greater than) 1.5, 2.0, 3.5, 3.7, or even 3.8 and/or the mole ratio of the chain extender to the polyol may go up to 5.0, or even 4.0.

The thermoplastic polyurethanes described herein may also be considered to be thermoplastic polyurethane (TPU) compositions. In such embodiments, the compositions may contain one or more TPU.

The described compositions include the TPU materials described above and also TPU compositions that include such TPU materials and one or more additional components. These additional components include other polymeric materials that may be blended with the TPU described herein. These additional components include one or more additives that may be added to the TPU, or blend containing the TPU, to impact the properties of the composition.

The TPU described herein may also be blended with one or more other polymers. The polymers with which the TPU described herein may be blended are not overly limited. In some embodiments, the described compositions include two or more of the described TPU materials. In some embodiments, the compositions include at least one of the described TPU materials and at least one other polymer, which is not one of the described TPU materials.

Polymers that may be used in combination with the TPU materials described herein also include more conventional TPU materials such as non-caprolactone polyester-based TPU, polyether-based TPU, or TPU containing both non-caprolactone polyester and polyether groups. Other suitable materials that may be blended with the TPU materials described herein include polycarbonates, polyolefins, styrenic polymers, acrylic polymers, polyoxymethylene polymers, polyamides, polyphenylene oxides, polyphenylene sulfides, polyvinylchlorides, chlorinated polyvinylchlorides, polylactic acids, or combinations thereof.

Polymers for use in the blends described herein include homopolymers and copolymers. Suitable examples include: (i) a polyolefin (PO), such as polyethylene (PE), polypropylene (PP), polybutene, ethylene propylene rubber (EPR), polyoxyethylene (POE), cyclic olefin copolymer (COC), or combinations thereof; (ii) a styrenic, such as polystyrene (PS), acrylonitrile butadiene styrene (ABS), styrene acrylonitrile (SAN), styrene butadiene rubber (SBR or HIPS), polyalphamethylstyrene, styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof; (iii) a thermoplastic polyurethane (TPU) other than those described above; (iv) a polyamide, such as Nylon™, including polyamide 6,6 (PA66), polyamide 1,1 (PA11), polyamide 1,2 (PA12), a copolyamide (COPA), or combinations thereof; (v) an acrylic polymer, such as polymethyl acrylate, polymethylmethacrylate, a methyl methacrylate styrene (MS) copolymer, or combinations thereof; (vi) a polyvinylchloride (PVC), a chlorinated polyvinylchloride (CPVC), or combinations thereof; (vii) a polyoxymethylene, such as polyacetal; (viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG), polylactic acid (PLA), polyglycolic acid (PGA), copolymers of PLA and PGA, or combinations thereof; (ix) a polycarbonate (PC), a polyphenylene sulfide (PPS), a polyphenylene oxide (PPO), or combinations thereof; or combinations thereof.

In some embodiments, these blends include one or more additional polymeric materials selected from groups (i), (iii), (vii), (viii), or some combination thereof. In some embodiments, these blends include one or more additional polymeric materials selected from group (i). In some embodiments, these blends include one or more additional polymeric materials selected from group (iii). In some embodiments, these blends include one or more additional polymeric materials selected from group (vii). In some embodiments, these blends include one or more additional polymeric materials selected from group (viii).

The additional additives suitable for use in the TPU compositions described herein are not overly limited. Suitable additives include pigments, UV stabilizers, UV absorbers, antioxidants, lubricity agents, heat stabilizers, hydrolysis stabilizers, cross-linking activators, flame retardants, layered silicates, fillers, colorants, reinforcing agents, adhesion mediators, impact strength modifiers, antimicrobials, and any combination thereof. Still further optional additives may be used in the TPU compositions described herein. The additives include colorants, antioxidants (including phenolics, phosphites, thioesters, and/or amines), antiozonants, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof. All of the additives described above may be used in an effective amount customary for these substances. In other embodiments, the TPU compositions is free of any of these additional additives.

In some embodiments, the hydroxyl terminated intermediate used to make the TPU described above includes a polyether polyol, a polyester polyol, a polycarbonate polyol, a polyamide polyol, or any combination thereof.

In some embodiments, the ionically conductive TPU composition of the separator is made by reacting (i) at least one hydroxyl terminated intermediate with (ii) at least one diisocyanate and (iii) at least one chain extender; wherein (i), the hydroxyl terminated intermediate, comprises a poly(ethylene glycol) or an intermediate derived from at least one dialkylene glycol and at least one di-carboxylic acid, or an ester or anhydride thereof; wherein (ii), the diisocyanate, comprises: 4,4′-methylenebis-(phenyl isocyanate); hexamethylene diisocyanate; 3,3′-dimethylbiphenyl-4,4′-diisocyanate; m-xylylene diisocyanate; phenylene-1,4-diisocyanate; naphthalene-1,5-diisocyanate; diphenylmethane-3,3′-dimethoxy-4,4′-diisocyanate; toluene diisocyanate; isophorone diisocyanate; 1,4-cyclohexyl diisocyanate; decane-1,10-diisocyanate; dicyclohexylmethane-4,4′-diisocyanate; or combinations thereof; wherein (iii), the chain extender, comprises: hydroquinone bis (beta-hydroxyethyl) ether; ethylene glycol; diethylene glycol; propylene glycol; dipropylene glycol; 1,4-butanediol; 1,6-hexanediol; 1,3-butanediol; 1,5-pentanediol; neopentylglycol; or combinations thereof; and wherein the di-carboxylic acid contains from 4 to 15 carbon atoms and the dialkylene glycol contains from 2 to 8 aliphatic carbon atoms.

In some embodiments, the ionically conductive thermoplastic polyurethane composition of the separator includes the reaction product of: (i) a 4,4′-methylenebis-(phenyl isocyanate), (ii) a hydroxyl terminated poly(ethylene glycol) or an intermediate derived from at least one dialkylene glycol and adipic acid, and (iii) and hydroquinone bis (beta-hydroxyethyl) ether.

In some embodiments, the ionically conductive thermoplastic polyurethane composition of the separator includes at least one additional additive, comprising a plasticizer, a lubricant, an antioxidant, a heat stabilizer, hydrolytic stabilizer, an acid scavenger, mineral and/or inert filler, a nano filler, a flame retardant, a second polymer component, a compatibilizer, or any combination thereof.

In some embodiments, the hydroxyl terminated intermediate includes a polyester polyol and may optionally include or exclude a polyether polyol, may optionally include or exclude a polycarbonate polyol, and may optionally include or exclude a polyamide polyol.

In some embodiments, the ionically conductive TPU composition of the separator is made by reacting (i) at least one hydroxyl terminated intermediate with (ii) at least one diisocyanate and (iii) at least one chain extender; wherein (i), the hydroxyl terminated intermediate, is a poly(ethylene glycol) or an intermediate derived from at least one dialkylene glycol and at least one di-carboxylic acid, or an ester or anhydride thereof; wherein (ii), the diisocyanate, is: 4,4′-methylenebis-(phenyl isocyanate); wherein (iii), the chain extender, is: hydroquinone bis (beta-hydroxyethyl) ether; ethylene glycol; diethylene glycol; propylene glycol; dipropylene glycol; 1,4-butanediol; 1,6-hexanediol; 1,3-butanediol; 1,5-pentanediol; neopentylglycol; or combinations thereof; and wherein the di-carboxylic acid contains from 4 to 15 carbon atoms and the dialkylene glycol contains from 2 to 8 aliphatic carbon atoms.

In some embodiments, the ionically conductive TPU composition of the separator is made by reacting (i) at least one hydroxyl terminated intermediate with (ii) at least one diisocyanate and (iii) at least one chain extender; wherein (i), the hydroxyl terminated intermediate, is a poly(ethylene glycol) or an intermediate derived from at least one dialkylene glycol and at least one di-carboxylic acid, or an ester or anhydride thereof; wherein (ii), the diisocyanate, is: 4,4′-methylenebis-(phenyl isocyanate); hexamethylene diisocyanate; 3,3′-dimethylbiphenyl-4,4′-diisocyanate; m-xylylene diisocyanate; phenylene-1,4-diisocyanate; naphthalene-1,5-diisocyanate; diphenylmethane-3,3′-dimethoxy-4,4′-diisocyanate; toluene diisocyanate; isophorone diisocyanate; 1,4-cyclohexyl diisocyanate; decane-1,10-diisocyanate; dicyclohexylmethane-4,4′-diisocyanate; or combinations thereof; wherein (iii), the chain extender, is: hydroquinone bis (beta-hydroxyethyl) ether; and wherein the di-carboxylic acid contains from 4 to 15 carbon atoms and the dialkylene glycol contains from 2 to 8 aliphatic carbon atoms.

In some embodiments, the ionically conductive TPU composition of the separator is made by reacting: (i) a poly(ethylene glycol) and at least one di-carboxylic acid, or an ester or anhydride thereof with (ii) at least one aromatic diisocyanate and (iii) at least one aromatic chain extender; wherein the di-carboxylic acid contains from 4 to 15 carbon atoms and the dialkylene glycol contains from 2 to 8 aliphatic carbon atoms.

In some embodiments, the ionically conductive TPU composition of the separator is made by reacting: (i) a poly(ethylene glycol) and at least one di-carboxylic acid, or an ester or anhydride thereof with (ii) 4,4′-methylenebis-(phenyl isocyanate); and (iii) hydroquinone bis (beta-hydroxyethyl) ether; wherein the di-carboxylic acid contains from 4 to 15 carbon atoms and the dialkylene glycol contains from 2 to 8 aliphatic carbon atoms.

The separator is melt coated onto the electrode, resulting in the integrated electrode assembly described herein. The electrode is described as an integrated assembly because it includes both the electrode and the separator in a single part, or assembly. Given the integrated nature of the assembly, the separator no longer needs to be wound separately during the construction of the electrochemical cell (i.e., battery), rather the separator and electrode are already assembled and only the other parts needed to complete the cell need to be added. This integrated electrode assembly allows the problems faced when attempting to use a TPU based separator to be avoided.

By melt coating, it is meant that the ionically conductive thermoplastic polyurethane composition is brought to the necessary coating viscosity, which allows the coating to be applied, by temperature rather than by solution of the polymer in a solvent or some other method. This may also referred to as hot melt coated. Hot melt coating may use slot-die coating at elevated (above ambient) temperature, that is temperature above the melt point of the polymeric material being used to form the coating. Similar means of applying a coating, including bar coating, hot melt extrusion, and co-extrusion, are also contemplated as within the scope of this invention and considered included in the term “melt coated” as used herein. In some embodiments, the term “melt coated” is used herein as meaning a coating applied by any means where the material forming the coating is applied in its melted state. That is, the ionically conductive thermoplastic polyurethane composition is in the form of a melt when it is applied to form the coating on the electrode. Any means of applying the coating, where the polymer is in the form of a melt, is considered to be included in the “melt coated” as used herein.

In some embodiments, the term “melt coated” as used herein includes any means of applying the coating, where the polymer is in the form of a melt, except by heat lamination.

Generally speaking, the melt coated separator of the present invention, made from the ionically conductive TPU composition, is essentially free of micro pores. While not wishing to be bound by theory, it is believed that the presence of micro pores, or at least a significant amounts of micro pores in the melt coated separator would result in failure, or at least a significant reduction in performance, of an electrochemical cell made with an integrated electrode assembly having such a melt coated separator. Further, it is believed that the ionically conductive TPU composition of the invention allows the melt coated separator to be essentially free of micro pores due to the properties and processing characteristics of the ionically conductive TPU composition. In addition, the ionically conductive TPU composition of the invention has good adhesion (especially when wet by electrolytes) to the types of materials used to make electrodes. Without this good adhesion melt coating a polymeric material onto an electrode would not result in an assembly with an effective separator. These features of the present invention are believed to allow the described integrated electrode assemblies to provide the benefits described herein.

The invention also provides a process of making an integrated electrode assembly including the steps of: (I) melt coating a separator which includes an ionically conductive thermoplastic polyurethane composition onto an electrode; and (B) a separator including a thermoplastic polyurethane composition; wherein the separator is melt coated onto the electrode. Any of the integrated electrode assemblies described above may be made by this process. Any of the ionically conductive thermoplastic polyurethane compositions described above may be used in this process.

### The Electrochemical Cell

The integrated electrode assemblies described herein may be used in the construction of electrochemical cells. The disclosed technology provides for such electrochemical cells made using the integrated electrode assemblies described herein.

According to another aspect of the present invention, there is provided a lithium battery containing at least one of the described integrated electrode assemblies. In some embodiments, the electrochemical cells contain one of the described integrated electrode assemblies, in combination with an electrode that does not include a melt coated separator. In some embodiments, the electrochemical cells contain two of the described integrated electrode assemblies (both electrodes in the battery include a melt coated separator).

Furthermore, the disclosed technology relates to the use of the integrated electrode assemblies defined herein in electrochemical cells such as a lithium battery. Electrochemical cells include batteries, such as the lithium ion batteries noted herein, and also include capacitors and similar devices, such as electric double-layer capacitors also referred to as super capacitors or ultra-capacitors.

In some embodiments, the electrochemical cells described herein include, disposed between the positive and negative electrodes, an electrolyte system. The electrolyte system may include an organic polymeric support structure adapted to engage, as for example, by absorption, an electrochemically active species or material. The electrochemically active material may be a liquid electrolyte, such as a metal salt that is dissolved in an organic solvent and which is adapted to promote ion transport between said positive and negative electrodes.

The electrochemical cells of the invention may have a charge/discharge cycle life of >500, >750 or even >1000 cycles. The electrochemical cells of the invention may have a charge/discharge efficiency of >90% or even >95% after 500 cycles. The electrochemical cells of the invention may have an operation window of −30 to 100° C., where any one or any combination of these performance characteristics are met over the defined operation window. The electrochemical cells of the invention may be essentially free of any rigid metallic casing and may even be completely free of any rigid metallic casing. The electrochemical cells of the invention may be a pouch type battery.

In still further embodiments, the electrochemical cells of the invention meet at least one of, or any combination of, the following characteristics: (i) a charge/discharge cycle life of >500, >750 or even >1000 cycles; (ii) a charge/discharge efficiency of >90% or even >95% after 500 cycles; (iii) an operation window of −30 to 100° C. or -0 to 70° C.

In some embodiments the ionically conductive thermoplastic polyurethane composition, as well as the separator and/or electrochemical cells containing said composition, are substantially free of inorganic solids. By substantially free, it is meant that the composition contains <10% by weight inorganic solids, or even <5% by weight or <1% by weight inorganic solids. In still other embodiments, the compositions are essentially free of, or even completely free of inorganic solids.

A suitable electrolytic solution of the electrochemical cell includes a lithium salt. Any lithium compound that dissolves in an organic solvent to produce lithium ions can be used as a lithium salt. For example, at least one ionic lithium salt such as lithium perchlorate (LiClO₄), lithium tetrafluoroborate (LiBF₄), lithium hexafluorophosphate (LiPF₆), lithium trifluoromethanesulfonate (LiCF₃SO₃), and lithium bis(trifluoromethanesulfonyl) amide (LiN(CF₃SO₂)₂) can be used. The halogen free salts described above may also be used, including lithium bis(oxalato)borate, lithium bis(glycolato)borate, lithium bis(lactato)borate, lithium bis(malonato)borate, lithium bis(salicylate)borate, lithium (glycolato, oxalato) borate, or combinations thereof. A concentration of the lithium salt may be in the range of 0.5-2.0M. If the concentration of the lithium salt is outside of this range, ionic conductivity may be undesirably low. An organic electrolytic solution containing such an inorganic salt is used so that a path through which lithium ions flow in a current flow direction can be formed.

Examples of the organic solvent for the electrolytic solution suitable for the present invention include polyglymes, oxolanes, carbonates, 2-fluorobenzene, 3-fluorobenzene, 4-fluorobenzene, dimethoxyethane, and diethoxyethane. These solvents may be used individually or in a combination of two or more.

Examples of polyglymes include diethyleneglycol dimethylether (CH₃(OCH₂CH₂)₂OCH₃), diethyleneglycol diethylether (C₂H₅(OCH₂CH₂)₂OC₂H₅), triethyleneglycol dimethylether (CH₃(OCH₂CH₂)₃OCH₃), and triethyleneglycol diethylether (C₂H₅(OCH₂CH₂)₃OC₂H₅). These polyglymes may be used individually or in a combination of two or more.

Examples of dioxolanes include 1,3-dioxolane, 4,5-diethyl-dioxolane, 4,5-dimethyl-dioxolane, 4-methyl-1,3-dioxolane, and 4-ethyl-1,3-dioxolane. These dioxolanes may be used individually or in a combination of two or more. Examples of carbonates include methylene carbonate, ethylene carbonate, diethyl carbonate, dimethyl carbonate, gamma-butyrolactone, propylene carbonate, dimethyl carbonate, methylethyl carbonate, diethyl carbonate, and vinylene carbonate. These carbonates may be used individually or in a combination of two or more.

The organic solvent may be a mixture of ethylene carbonate (EC), ethylmethyl carbonate (EMC), propylene carbonate (PC), and fluorobenzene (FB); and a mixture of diglyme (DGM) (also called as “diethyleneglycol dimethylether”), dimethoxyethane (DME), and 1,3-dioxolane (DOX).

The amount of the organic solvent may be the same as that of an organic solvent used in a conventional lithium battery.

The electrolytic solution according to an embodiment of the present invention is added by using the conventional methods when manufacturing lithium batteries. The conventional methods include, but are not limited to, the following methods: (1) A method including injecting the electrolytic solution into a capsulated electrode assembly, which includes a cathode, an anode and a separator; (2) A method including: coating electrodes or a separator or an integrated electrode assembly with a polymer electrolyte containing a matrix forming resin and the electrolytic solution; forming an electrode assembly using the coated electrodes and separator; and sealing the electrode assembly in a battery case; or (3) A method including: coating electrodes or a separator or an integrated electrode assembly with a polymer electrolyte containing a matrix forming resin and the electrolytic solution; forming an electrode assembly using the coated electrodes and separator; sealing the electrode assembly in a battery case; and polymerizing inside of the battery. Here, this method can be applied when a freepolymer or polymerization monomer is used as the matrix forming resin.

Any material that is commonly used as a binder of an electrode plate can be used as a matrix forming polymer resin in the method according to the present invention without limitation. Examples of the matrix forming polymer resin include vinylidene fluoride/hexafluoropropylene copolymer, polyvinylidenefluoride, polyacrylonitrile, polymethylmethacrylate and combinations of these materials.

The matrix forming polymer resin may further include a filler that enhances mechanical strength of the polymer electrolyte. Examples of the filler include silica, kaolin, and alumina. In addition, the matrix forming polymer resin can further include a plasticizer if needed.

The electrolytic solution according to the present invention can be used in common lithium batteries, such as primary batteries, secondary batteries, and sulfur batteries.

The electrolytic solution according to the present invention can be used in cylindrical and rectangular lithium batteries, without limitation.

In some embodiments, the invention further provides for an electrolyte system which combines the mechanical stability and freedom from leakage offered by solid electrolytes with the high ionic conductivities of liquid electrolytes. The electrolyte system may comprise an organic polymeric support structure adapted to engage, as for example, by absorption, an electrochemically active species or material. The electrochemically active material may be a liquid electrolyte, such as a metal salt that is dissolved in an organic solvent and which is adapted to promote ion transport between the positive and negative electrodes of an electrochemical cell (or battery).

The liquid electrolyte absorbed by the organic support structure may be selected to optimize performance of the positive and negative electrodes. In one embodiment, for a lithium based electrochemical cell, the liquid electrolyte absorbed by the organic support structure is typically a solution of an alkali metal salt, or combination of salts, dissolved in an aprotic organic solvent or solvents. Typical alkali metal salts include, but are not limited to, salts having the formula M⁺X⁻ where M⁺ is a alkali metal cation such as Li+, Na⁺, K⁺ and combinations thereof and X⁻ is an anion such as Cl⁻, Br⁻, I⁻, ClO₄⁻, BF₄⁻, PF₅⁻, AsF₆⁻, SbF₆⁻, CH₃CO₂⁻, CF₃SO₃⁻, (CF₃O₂)₂N⁻, (CF₃SO₂)₂N⁻, (CF₃SO₂)₃C⁻, B(C₂O₄)⁻, and combinations thereof. In some embodiments, these salts are all lithium salts. Aprotic organic solvents include, but are not limited to, propylene carbonate, ethylene carbonate, diethyl carbonate, dimethyl carbonate, dipropyl carbonate, dimethyl sulfoxide, acetonitrile, dimethoxyethane, diethoxyethane, tetrahydrofuran, ethyl methyl carbonate, and combinations thereof.

The organic polymeric support structure may be fabricated of any of the polyurethane elastomers compositions described above.

In some embodiments, the electrolyte system for an electrochemical cell comprises an electrolyte active species dispersed in a polymeric support structure comprising a poly(dialkylene ester) thermoplastic polyurethane composition made by reacting (i) at least one poly(dialkylene ester) polyol intermediate with (ii) at least one diisocyanate and (iii) at least one chain extender; wherein (i), the polyester polyol intermediate, comprises an intermediate derived from at least one dialkylene glycol and at least one di-carboxylic acid, or an ester or anhydride thereof.

The instant electrolyte system may also have the important advantage of having a polymeric support structure which is easily processable and reprocessable, since the materials are thermoplastic elastomers. Other prior art gel systems are typically permanently chemically cross-linked either by radiation (e-beam, UV, etc.) or by using a chemical crosslinking agent, for example, diisocyanates which can be used to cross-link polyether triols.

In still other embodiments, the electrolyte system may be a polymer gel electrolyte system where the electrolyte system is a homogeneous gel that includes the poly(dialkylene ester) thermoplastic polyurethane composition described above, an alkali metal salt, and an aprotic organic solvent.

As noted above, where the described electrochemical include an integrated electrode assembly and a conventional electrode (i.e., not an integrated electrode assembly) the conventional electrode may be any electrode commonly used in electrochemical cells.

Any conventional organic solvent that is used in common batteries can be used in the present invention without particular limitation. However, the organic solvent may be a compound having relatively strong dipole moments. Examples of the compound include dimethylformamide (DMF), dimethylsulfoxide (DMSO), dimethyl acetamide (DMA), acetone, and N-methyl-2-pyrrolidone (hereinafter referred as NMP). In some embodiments the solvent is NMP. The ratio of thermoplastic polyurethane compositions to the organic solvent may be 1:0.1 through 100 (by weight).

Any conducting agent that is commonly used in the art can be used in the present invention without particular limitation. Examples of the conducting agent include carbon black and nickel powder. The amount of the conducting agent may be in the range of 0-10% by weight, preferably 1-8% by weight, based on the electrode composition. These conducting agents may be referred to as cathode or anode powders.

In some embodiments, the electrochemical cells include: (I) an integrated electrode assembly comprising: (A) an electrode; and (B) a first separator comprising an ionically conductive thermoplastic polyurethane composition; wherein the first separator is melt coated onto the electrode; (II) an electrode which is not melt coated with a thermoplastic polyurethane composition; and (III) an electrolyte.

In some embodiments, the electrochemical cells include: (I) an integrated electrode assembly comprising: (A) an anode; and (B) a first separator comprising an ionically conductive thermoplastic polyurethane composition; wherein the first separator is melt coated onto the anode; (II) an integrated electrode assembly comprising: (C) a cathode; and (D) a second separator comprising a ionically conductive thermoplastic polyurethane composition; wherein the second separator is melt coated onto the cathode; and (III) an electrolyte.

In some embodiments, the electrochemical cells are lithium ion batteries, and include: (I) an integrated electrode assembly comprising: (A) an electrode; and (B) a first separator comprising an ionically conductive thermoplastic polyurethane composition; wherein the first separator is melt coated onto the electrode; (II) an electrode which is not melt coated with a thermoplastic polyurethane composition; and (III) an electrolyte.

In some embodiments, the electrochemical cells are lithium ion batteries, and include: (I) an integrated electrode assembly comprising: (A) an anode; and (B) a first separator comprising an ionically conductive thermoplastic polyurethane composition; wherein the first separator is melt coated onto the anode; (II) an integrated electrode assembly comprising: (C) a cathode; and (D) a second separator comprising a ionically conductive thermoplastic polyurethane composition; wherein the second separator is melt coated onto the cathode; and (III) an electrolyte.

In some embodiments, the electrochemical cells are lithium ion batteries, and include: (I) an integrated electrode assembly comprising: (A) an electrode; and (B) a first separator comprising an ionically conductive thermoplastic polyurethane composition; wherein the first separator is melt coated onto the electrode; (II) an electrode which is not melt coated with a thermoplastic polyurethane composition; and (III) an electrolyte; wherein the ionically conductive thermoplastic polyurethane composition of the separator is made by reacting (i) a poly(ethylene glycol) and at least one di-carboxylic acid, or an ester or anhydride thereof with (ii) at least one aromatic diisocyanate and (iii) at least one aromatic chain extender; wherein the di-carboxylic acid contains from 4 to 15 carbon atoms and the dialkylene glycol contains from 2 to 8 aliphatic carbon atoms.

In some embodiments, the electrochemical cells are lithium ion batteries, and include: (I) an integrated electrode assembly comprising: (A) an anode; and (B) a first separator comprising an ionically conductive thermoplastic polyurethane composition; wherein the first separator is melt coated onto the anode; (II) an integrated electrode assembly comprising: (C) a cathode; and (D) a second separator comprising a ionically conductive thermoplastic polyurethane composition; wherein the second separator is melt coated onto the cathode; and (III) an electrolyte; wherein the ionically conductive thermoplastic polyurethane composition of the separator is made by reacting (i) a poly(ethylene glycol) and at least one di-carboxylic acid, or an ester or anhydride thereof with (ii) at least one aromatic diisocyanate and (iii) at least one aromatic chain extender; wherein the di-carboxylic acid contains from 4 to 15 carbon atoms and the dialkylene glycol contains from 2 to 8 aliphatic carbon atoms.

In some embodiments, the electrochemical cells are lithium ion batteries, and include: (I) an integrated electrode assembly comprising: (A) an electrode; and (B) a first separator comprising an ionically conductive thermoplastic polyurethane composition; wherein the first separator is melt coated onto the electrode; (II) an electrode which is not melt coated with a thermoplastic polyurethane composition; and (III) an electrolyte; wherein the ionically conductive thermoplastic polyurethane composition of the separator is made by reacting (i) a poly(ethylene glycol) and at least one di-carboxylic acid, or an ester or anhydride thereof with (ii) 4,4′-methylenebis-(phenyl isocyanate); and (iii) hydroquinone bis (beta-hydroxyethyl) ether; wherein the di-carboxylic acid contains from 4 to 15 carbon atoms and the dialkylene glycol contains from 2 to 8 aliphatic carbon atoms.

In some embodiments, the electrochemical cells are lithium ion batteries, and include: (I) an integrated electrode assembly comprising: (A) an anode; and (B) a first separator comprising an ionically conductive thermoplastic polyurethane composition; wherein the first separator is melt coated onto the anode; (II) an integrated electrode assembly comprising: (C) a cathode; and (D) a second separator comprising a ionically conductive thermoplastic polyurethane composition; wherein the second separator is melt coated onto the cathode; and (III) an electrolyte; wherein the ionically conductive thermoplastic polyurethane composition of the separator is made by reacting (i) a poly(ethylene glycol) and at least one di-carboxylic acid, or an ester or anhydride thereof with (ii) 4,4′-methylenebis-(phenyl isocyanate); and (iii) hydroquinone bis (beta-hydroxyethyl) ether; wherein the di-carboxylic acid contains from 4 to 15 carbon atoms and the dialkylene glycol contains from 2 to 8 aliphatic carbon atoms.

In some embodiments, the polyurethane based coating may act as a solid electrolyte. In such embodiments the electrochemical cells made using such an assembly would be identical to any of those described above expect that no electrolyte would need to be added, since the ionically conductive thermoplastic polyurethane composition melt coated onto the electrode would act as the electrolyte as well as the separator.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

The invention may be better understood with reference to the following examples.

### Example Set 1

Two materials are provided which are used as a coating on the electrode assembly.

### Example 1-A (TPU1)

An ionically conductive thermoplastic polyurethane composition is made by reacting (i) a poly(ethylene glycol) and adipic acid with (ii) 4,4′-methylenebis-(phenyl isocyanate); and (iii) hydroquinone bis (beta-hydroxyethyl) ether, using conventional techniques. Example 1-A is referred to in the table below as TPU1.

### Example 1-B (PE1)

A comparative material, a Celgard® polyethylene is used, referred to in the table below as PE1.

### Example Set 2

A set of example lithium ion batteries is prepared using two different thicknesses for separator, and in some examples, the melt coated separator applied to the electrode, two types of cathode electrodes, and one type of anode electrodes. Examples 1-A and 1-B are used for the separators.

The batteries are each prepared by using commercially available electrodes. Both the anode and the cathode for each samples were taped down onto a backing film and then a separator film made of TPU1 or PE1 is laid on the electrode, and for some examples the separator is melt-coated with TPU1 or PE1 as indicated below. The coated electrodes and samples of uncoated electrodes were then carefully cut into rectangular shapes, and then manually stacked into configurations illustrated in Table 1. These pre-assembled layers were then dried, electrolyte filled, degassed, sealed, formed and tested according to the proprietary procedures of a third party battery testing laboratory.

The table below summarizes the examples batteries and the results achieved. Examples where the integration of the separator and electrode is described as “none” indicate batteries where the separator is inserted as a freestanding film which is not melt coated onto the electrode. Examples where the integration of the separator and electrode is described as “melt coated” indicate batteries where the separator is melt coated onto the electrode providing an integrated electrode assembly. Also indicated is whether the separator is melt coated onto the cathode, anode, or both.

TABLE 1

| | | | | | | Cycle |
|---|---|---|---|---|---|---|
| | | | | | Capacity | Efficiency |
| Example | Separator | Cathode | Anode | Integration | (mAh) | (%) |
| Comp 1 | PE1 | LiNiMnCoO₂ | Composite | None | 46.8 | 84.6 |
| | at 25 μm | | Graphite | | | |
| Comp 2 | TPU1 | LiNiMnCoO₂ | Composite | None | 45.7 | 82.1 |
| | at 25 μm | | Graphite | | | |
| Comp 3 | TPU1 | LiFePO₄ | Composite | None | 27.5 | 75.7 |
| | at 25 μm | | Graphite | | | |
| Inv 4 | TPU1 | LiFePO₄ | Composite | Melt Coated | 27.0 | 74.0 |
| | at 25 μm | | Graphite | Cathode | | |
| Inv 5 | TPU1 | LiFePO₄ | Composite | Melt Coated | 30.2 | 77.3 |
| | at 25 μm | | Graphite | Anode | | |
| Inv 6 | TPU1 | LiFePO₄ | Composite | Melt Coated | 30.0 | 79.5 |
| | at 2 × 14 μm | | Graphite | Both | | |
| Inv 7 | TPU1 | LiFePO₄ | Composite | Melt Coated | 27.5 | 73.0 |
| | at 14 μm | | Graphite | Anode | | |

Cell capacity was measured by constant current (6 mA) charging to 3.7V. For each sample the cell was then allowed to rest for 30 minutes and then the cell was discharged to 2.2V at 6 mA. The measurements were carried out on a Arbin BT2000 instrument at room temperature. The cycle efficiency was measured by discharge capacity/charge capacity for correspondent cycle.

The results show that using the integrated electrode assemblies described herein, working batteries, made using TPU base separators melt coated onto the electrodes are possible.

Comparative Example 1 uses a free-standing conventional PE film separator while Comparative Example 2 uses a free-standing TPU film separator. The results show Comparative Examples 1 and 2 are comparable, meaning a TPU film separator can be used to make functioning batteries. The only barrier, as discussed above, is the difficulty in producing batteries with a free-standing TPU film separator in commercial production processes.

Comparative Example 3 uses a free-standing TPU film separator while Inventive Examples 4 to 7 use an integrated electrode with a melt coated TPU separator. The Inventive Examples use multiple thicknesses and include examples where the anode is coated, where the cathode is coated, and where both are coated. These Inventive Examples show that batteries made with an integrated electrode with a melt coated TPU separator have performance properties at least as good as batteries made with a free-standing TPU film separator.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements. Unless otherwise noted all molecular weight values presented here are number average molecule weights. Further unless otherwise noted, all molecular weight values (weight average or number average) have been measured by GPC.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. An integrated electrode assembly comprising (A) an electrode; and (B) a separator comprising an ionically conductive thermoplastic polyurethane composition wherein the ionically conductive thermoplastic polyurethane composition of the separator comprises the reaction product of: (i) a diisocyanate, (ii) a hydroxyl-terminated poly(ethylene glycol) or an intermediate derived from at least one dialkylene glycol and adipic acid, and (iii) hydroquinone bis (beta-hydroxyethyl) ether;
wherein the separator is melt coated onto the electrode.

2. The integrated electrode assembly of claim 1 wherein the electrode comprises (i) a current collector, (ii) an electro-active material, (iii) an electrode binder composition, and optionally (iv) a conducting agent.

3. The integrated electrode assembly of claim 2 wherein the electrode binder composition comprises a polyvinylidene fluoride (PVDF), a styrene-butadiene rubber (SBR), a thermoplastic polyurethane (TPU), or a combination thereof.

4. The integrated electrode assembly of claim 2 wherein the conducting agent comprises carbon black, carbon nanotube, graphene, nickel powder, or a combination thereof.

5. The integrated electrode assembly of claim 2 wherein the electro-active material is a cathode active material selected from the group consisting of: lithium composite oxides; elemental sulfur; casolite containing dissolved Li₂Sₙ where n is greater than or equal to 1; organosulfur; (C₂Sₓ)_{y} where x is from 2.5 to 20 and y is greater than or equal to 2; and a combination thereof.

6. The integrated electrode assembly of claim 2 wherein the electro-active material is an anode active material selected from the group consisting of: a graphite-based material; a first compound containing at least one of Al, Si, Sn, Ag, Bi, Mg, Zn, In, Ge, Pb, and Ti; a composite of the first compound, the graphite-based material, and carbon; a lithium-containing nitride; and a combination thereof.

7. (canceled)

8. (canceled)

9. (canceled)

10. The integrated electrode assembly of claim 1 wherein the diisocyanate comprises a 4,4′-methylenebis-(phenyl isocyanate).

11. The integrated electrode assembly of claim 1 wherein the ionically conductive thermoplastic polyurethane composition of the separator further comprises at least one additional additive, comprising a plasticizer, a lubricant, an antioxidant, a heat stabilizer, hydrolytic stabilizer, an acid scavenger, mineral and/or inert filler, a nano filler, a flame retardant, a second polymer component, a compatibilizer, or any combination thereof.

12. (canceled)

13. An electrochemical cell comprising:
(I) an integrated electrode assembly comprising: (A) an electrode; and (B) a first separator comprising an ionically conductive thermoplastic polyurethane composition; wherein the first separator is melt coated onto the electrode and wherein the ionically conductive thermoplastic polyurethane composition of the first separator comprises the reaction product of: (i) a diisocyanate, (ii) a hydroxyl-terminated poly(ethylene glycol) or an intermediate derived from at least one dialkylene glycol and adipic acid, and (iii) hydroquinone bis (beta-hydroxyethyl) ether;
(II) an electrode which is not melt coated with a thermoplastic polyurethane composition; and
(III) an electrolyte.

14. (canceled)

15. A process of making an integrated electrode assembly comprising:
melt coating a separator which comprises an ionically conductive thermoplastic polyurethane composition onto an electrode wherein the ionically conductive thermoplastic polyurethane composition of the first separator comprises the reaction product of: (i) diisocyanate, (ii) a hydroxyl-terminated poly(ethylene glycol) or an intermediate derived from at least one dialkylene glycol and adipic acid, and (iii) hydroquinone bis (beta-hydroxyethyl) ether.
